(19) United States
(12) Patent Application Publication
(10) Pub. No.: US 2010/0325050 A1
(43) Pub. Date: Dec. 23, 2010

(54) CONTROL METHOD FOR A PRINT PROCESSING DEVICE, CONTROL METHOD FOR A RECEIPT PRINTING DEVICE, A PRINT PROCESSING DEVICE, A RECEIPT ISSUING SYSTEM, AND A PROGRAM

(75) Inventors: Kiyoshi Ito, Matsumoto-shi (JP); Toshio Kuriyama, Matsumoto-shi (JP); Akira Miyagawa, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/817,894

(22) Filed: Jun. 17, 2010

(30) Foreign Application Priority Data
Jun. 17, 2009 (JP) 2009-143917
May 11, 2010 (JP) 2010-109032

(51) Int. Cl. H04L 9/28; G06Q 30/00; B42D 15/00

(52) U.S. Cl. 705/50; 380/28; 283/73

(57) ABSTRACT

A method and system are provided for a receipt printing device that produces receipts. Encrypted data is necessary to produce the receipt to prevent forgery of the receipt. The encrypted data based on information, which can be transaction information, received from a POS terminal. The encrypted data will be printed on the receipt only when determined to be necessary.

This application claims priority to Japanese Patent Application No. 2009-143917, filed Jun. 17, 2009 and Japanese Patent Application No. 2010-109032, filed May 11, 2010. The entireties of both of the aforementioned application are incorporated by reference herein.

### BACKGROUND

The present invention relates to a system and method of controlling a print processing device that produces printed output, and more specifically for printing receipts for which forgery prevention is necessary, to a method of controlling a receipt printer, to a print processing device, and to a receipt issuing system.

A method of printing hardcopy output for which preventing counterfeiting is important is taught, for example, in Japanese Unexamined Patent Appl. Pub. JP-A-2002-326443. JP-A-2002-326443 teaches using specialty inks such as visible ink, fluorescent ink, and infrared-absorbing ink to print plural information blocks, thereby making counterfeiting difficult and enabling easy identification of forgeries.

Japanese Unexamined Patent Appl. Pub. JP-A-2001-236487 also relates to printed output that is protected from counterfeiting by similarly using specialty inks More specifically, JP-A-2001-236487 teaches recording encrypted authenticity verification data on a negotiable instrument using stealth ink as a means of preventing illegal use of the negotiable instrument.

A problem with the technology taught in JP-A-2002-326443, however, is that the operating cost is high because plural types of expensive specialty inks are used for printing. In addition, because the printing device taught in JP-A-2002-326443 prints based on print data acquired from an external command device, modification of the external command device is required to achieve a forgery prevention function, and the initial cost is therefore increased.

Furthermore, JP-A-2001-236487 teaches printing with stealth ink on different types of card media and negotiable instruments such as stock certificates, but the operating cost is high when used for high volume printing applications.

Counterfeit receipts are also a problem. A forged receipt can be used to remove stolen goods from a store. They can even be used to return stolen goods to a store in exchange for cash. Effective anti-counterfeiting measures are therefore needed to prevent forgery of receipts.

### SUMMARY

The present invention is directed to a method of controlling a print processing device that can produce printed output with highly effective anti-counterfeiting measures without incurring great cost, a control method for a receipt printing device, a print processing device, and to a receipt issuing system.

A first aspect of the invention is a control method for a print processing device that produces printed output, including as steps executed by the print processing device: a forgery prevention determination step of determining if encrypted data is necessary based on first information, which is variable information; an encrypted data generating step of generating the encrypted data using at least a part of the first information when encrypted data is determined necessary in the forgery prevention determination step; and a printing step of printing the first information and the encrypted data when the encrypted data is determined necessary in the forgery prevention determination step, and printing only the first information when the encrypted data is determined unnecessary.

Another aspect of the invention is a print processing device that produces printed output, and has a forgery prevention determination unit that determines if encrypted data is necessary based on first information, which is variable information; an encrypted data generating unit that generates the encrypted data using at least a part of the first information when encrypted data is determined necessary by the forgery prevention determination unit; and a printing unit that prints the first information and the encrypted data when the encrypted data is determined necessary by the forgery prevention determination unit, and prints only the first information when the encrypted data is determined unnecessary.

With these aspects of the invention the need for the encrypted data is determined based on first information, which is variable information, and the encrypted data is generated and printed only when the encrypted data is determined to be necessary. In other words, because the encrypted data is not generated and printed when the encrypted data is determined to not be necessary, the operating cost required to print encrypted data to prevent counterfeiting can be reduced. In addition, by using encrypted data as an anti-counterfeiting measure, both forgery prevention and security can be improved.

Note that the method of printing the printed matter is not limited to any particular method, and inkjet printing, thermal printing, dot impact printing, and thermal transfer printing methods, for example, can be used.

In a control method for a print processing device according to another aspect of the invention, the print processing device further executes a second information reading step that reads second information, which is information unique to the print processing device, from a specific storage area; and in the encrypted data generating step, generates the encrypted data using the first information and the second information.

Because encrypted data is generated using second information, which is information unique to the print processing device, in this aspect of the invention, which print processing device printed the printed output can be determined by decrypting the encrypted data. As a result, the reliability of the printed output can be improved.

Another aspect of the invention is control method for a receipt printing device that is used connected to a POS terminal, the control method including as steps executed by the receipt printing device: a transaction information acquisition step that acquires transaction information, which is a result of a transaction process of the POS terminal, from the POS terminal; and a forgery prevention determination step of determining if encrypted data is necessary based on the transaction information. The receipt printing device also executes an encrypted data generating step of generating encrypted data using at least a part of the transaction information when encrypted data is determined necessary in the forgery prevention determination step; and a printing step of printing the transaction information and the encrypted data when encrypted data is determined necessary in the forgery prevention determination step, and printing only the transaction information when encrypted data is determined unnecessary.

This aspect of the invention can prevent counterfeiting of receipts that are issued in conjunction with the transaction process. In addition, because printing the encrypted data is limited to when encrypted data is determined necessary based on the transaction information, the operating cost incurred by receipt printing can be reduced. The effect of reducing this cost is particularly great when the receipt is printed output that is produced in large quantities. Furthermore, because the forgery prevention function is rendered by the receipt printing device, existing POS terminals can be used. Thus, because modification of the POS terminal is not necessary, the initial cost can be reduced.

In a control method for a receipt printing device according to another aspect of the invention, the receipt printing device further executes a device information reading step of reading device information, which is information unique to the receipt printing device, from a specific storage area; and in the encrypted data generating step, generates the encrypted data using the transaction information and the device information.

Because encrypted data is generated using device information of the receipt printing device in this aspect of the invention, which print processing device printed the printed output can be determined by decrypting the encrypted data. As a result, the reliability of the receipt can be improved.

In a control method for a receipt printing device according to another aspect of the invention, encrypted data is determined necessary by the forgery prevention determination step if a transaction total contained in the transaction information exceeds a specific amount.

In a control method for a receipt printing device according to another aspect of the invention, encrypted data is determined necessary by the forgery prevention determination step if product information for a specific product is contained in the transaction information.

In a control method for a receipt printing device according to another aspect of the invention, encrypted data is determined necessary by the forgery prevention determination step if the number of products contained in the transaction information exceeds a specific number.

These aspects of the invention can prevent significant losses to a retail store because encrypted data is printed when the transaction total is high, when specific products (such as products that are easily converted to cash or resold, loss leaders and other products that sell out easily, and premium products) are purchased, and when a large number of products are purchased, for example.

Note that a configuration in which the user can set, for example, the specific amount that is used as the evaluation standard of the transaction total, or the type of special products or the number that are used for evaluating the number of purchased products, is also conceivable. A configuration enabling setting which evaluation conditions are used, and whether the conditions are tested with an OR condition or an AND condition, is also conceivable.

In a control method for a receipt printing device according to another aspect of the invention, in the forgery prevention determination step, a forgery prevention rank is determined together with determining if encrypted data is necessary based on the transaction information; and in the encrypted data generating step, the encrypted data is generated using an encryption method corresponding to the forgery prevention rank.

Because the forgery prevention rank is determined based on the transaction information and the encrypted data is generated using an encryption method corresponding to the result, large retail store losses can be effectively prevented by, for example, using a more complex encryption method when the potential loss from a forged receipt is large.

Note that the encryption method preferably becomes more complex as the forgery prevention rank rises, such as by using DES, triple DES, and AES, for example. In addition, private key encryption, public key encryption, and other encryption methods can be used as well as shared key encryption methods. In addition, when the forgery prevention rank is low, a method using a password that can be known to a specific person may be used. In some embodiments, the encoding or encryption method is not specifically limited.

In a control method for a receipt printing device according to another aspect of the invention, the encrypted data functions as an exchange number or a lottery number for receiving an incentive.

Because the encrypted data functions as an exchange number or lottery number for receiving an incentive (such as a coupon, money order, or gift certificate) in this aspect of the invention, discarding the receipt can be prevented. As a result, illegal activities such as someone picking up a discarded receipt and using it to return a product from inside the store, or copying a receipt and producing a counterfeit receipt, can be prevented.

In a control method for a receipt printing device according to another aspect of the invention, the encrypted data is printed using invisible ink in the printing step.

Because the encrypted data is printed using invisible ink in this aspect of the invention, duplicating the receipt can be made more difficult and the anti-counterfeiting effect can therefore be improved.

It should be understood that “invisible ink” as used herein includes stealth ink, fluorescent ink, infrared ink, or other ink that is made visible by light, media that are made visible by heat, chemical reaction, or change in paper properties, and other types of coatings that are made visible by applying a specific process.

Another aspect of the invention is a receipt issuing system having a receipt printing device, a customer terminal, and a web server connected over a network. The receipt printing device includes a transaction information acquisition unit that acquires transaction information, which is a result of a transaction process of the POS terminal, from a POS terminal; a forgery prevention determination unit that determines if encrypted data is necessary based on the transaction information; and an encrypted data generating unit that generates encrypted data using at least a part of the transaction information when encrypted data is determined necessary by the forgery prevention determination unit. The receipt printing device also has a printing unit that prints the transaction information and the encrypted data when encrypted data is determined necessary by the forgery prevention determination unit, and prints only the transaction information when encrypted data is determined unnecessary, and a receipt information sending unit that sends receipt information including the transaction information to the web server when encrypted data is determined necessary by the forgery prevention determination unit.

In addition, the customer terminal includes a personal information input unit that accesses the web server, specifies the receipt information using a part of the transaction information, and inputs personal information. The web server has a database that stores the receipt information acquired from the receipt printing device and the personal information acquired from the customer terminal linked together, an incentive recipient selection unit that determines an incentive recipient from the receipt information stored in the database, and a recipient notification sending unit that sends the result of the selection decision by the incentive recipient selection unit to the customer terminal.

With this aspect of the invention counterfeiting receipts that are issued in conjunction with a transaction process can be prevented without incurring high operating costs. In addition, because the information (transaction information) printed on the receipt is required to receive the incentive, discarding of the receipt by the customer can be prevented. As a result, illegal activities such as someone picking up a discarded receipt and using it to return a product from inside the store, or copying a receipt and producing a counterfeit receipt, can be prevented. In addition, because notification that an incentive has been won is sent to the customer terminal, the need for customers to visit a store just to check if they have won can be eliminated. This system can also stimulate introduction of a CRM (customer relationship management) system such as a member registration system, and personal information about customers can be acquired by using the system. In addition, personal information can be collected with the related receipt information for use as marketing information, and can be useful for developing marketing strategies.

Note that the incentive recipient selection unit may also award the actual incentive after the incentive recipient is decided. For example, a process such as generating print data for an award certificate or coupon, or writing a discount amount to the customer database, may also be executed. In the former case, however, the print data for the certificate or coupon is sent to the customer terminal.

The incentive recipient selection unit may conduct a lottery and decide the recipient of the incentive according to the result of the lottery.

In a receipt issuing system according to another aspect of the invention, the receipt printing device also has a device information reading unit that reads device information, which is information unique to the receipt printing device, from a specific storage area; and the encrypted data generating unit generates the encrypted data using the transaction information and the device information.

Because the encrypted data is generated using device information about the receipt printing device in this aspect of the invention, the receipt printing device which printed the receipt can be determined by decrypting the encrypted data. As a result, the reliability of the receipt can be improved.

In a receipt issuing system according to another aspect of the invention, the receipt information sending unit sends the transaction information and the device information to the web server; and the incentive recipient selection unit determines the incentive based on the transaction information and the device information.

This aspect of the invention enables awarding an appropriate incentive according to the transaction information or device information such as by changing the incentive award rate according to the transaction information, awarding an incentive according to the purchased products, or awarding an incentive according to the region based on the device information.

Another aspect of the invention is a program that causes a computer to execute the steps in the print processing device control method described above, or the steps in the receipt printing device control method described above.

This aspect of the invention enables rendering a control method for a print processing device or a control method for a receipt printing device that can produce printed output (e.g., receipts) with excellent counterfeiting protection without incurring great cost.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram showing a receipt issuing system, according to an embodiment of the invention.

FIG. 2 is a control block diagram of the receipt issuing system, according to an embodiment of the invention.

FIG. 3 shows an example of a printed receipt, according to an embodiment of the invention.

FIG. 4 shows an example of information stored in a database located on a web server, and to an example of a coupon, according to an embodiment of the invention.

FIG. 5 is a function block diagram of the receipt issuing system, according to an embodiment of the invention.

FIG. 6 is a flow chart of the printing process of the receipt printer, according to an embodiment of the invention.

FIG. 7 is a flow chart showing the anti-counterfeiting determination process of the receipt printer, according to an embodiment of the invention.

### DESCRIPTION OF EMBODIMENTS

Preferred embodiments of a method of controlling a print processing device, a control method for a receipt printing device, a print processing device, and a receipt issuing system according to embodiments of the invention are described below with reference to the accompanying figures.

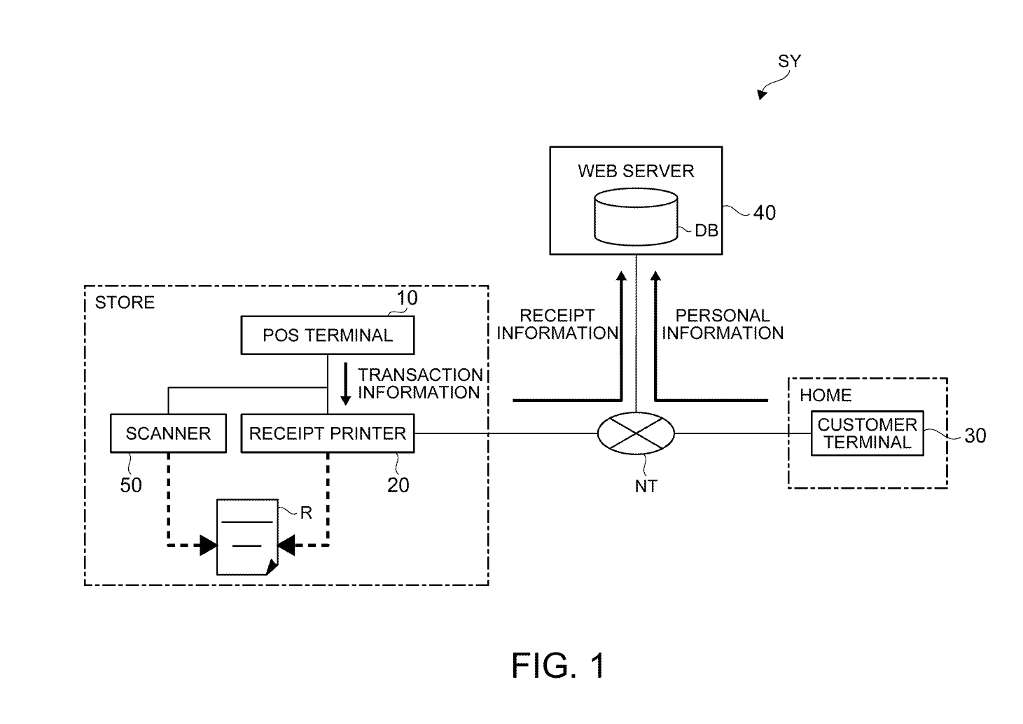

FIG. 1 is a block diagram of a receipt issuing system SY. A receipt issuing system SY according to this embodiment of the invention includes a POS terminal 10 for handling sales transactions, a receipt printer 20 for printing sales receipts R (referred to as simply “receipt R” below), a customer terminal 30 that is operated by a customer, a web server 40 that is accessed over the web, and a scanner 50 that reads and determines the authenticity of a receipt R. Note that the “print processing device” in the accompanying claims is rendered by the receipt printer 20. In addition, the “receipt issuing system” in the accompanying claims is rendered by the receipt printer 20, the customer terminal 30, and the web server 40.

The POS terminal 10, receipt printer 20, and scanner 50 are located in a business such as a retail store. The receipt printer 20 prints receipts R based on transaction information (i.e., first information) acquired from the POS terminal 10. Note that in this embodiment of the invention the receipt printer 20 is configured to be directly connected to the Internet or other network NT, but may instead be configured to connect to the network NT through the POS terminal 10.

The customer terminal 30 is an information processing terminal with a network NT connection function, and can be deployed using a personal computer located in a customer's residence or using a device such as a cell phone that travels with the user. Note that the customer terminal 30 in this embodiment of the invention is used for inputting the customer's personal information to the web server 40.

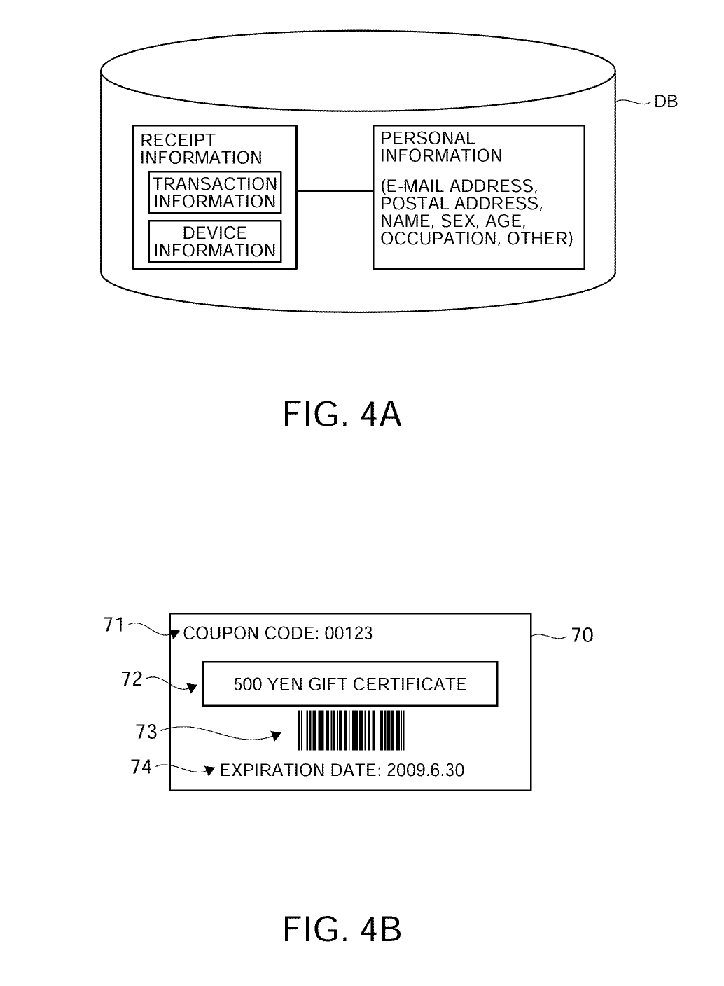

The web server 40 is connected to the network NT, acquires receipt information containing the foregoing transaction information from the receipt printer 20, acquires personal information from the customer terminal 30, and stores the transaction information linked to the personal information in the database DB. At a regular or otherwise specified time a lottery is held to select receipt information stored in the database DB, and a coupon 70 (see FIG. 4B) is sent as the prize to the customer terminal 30 of the winning customer.

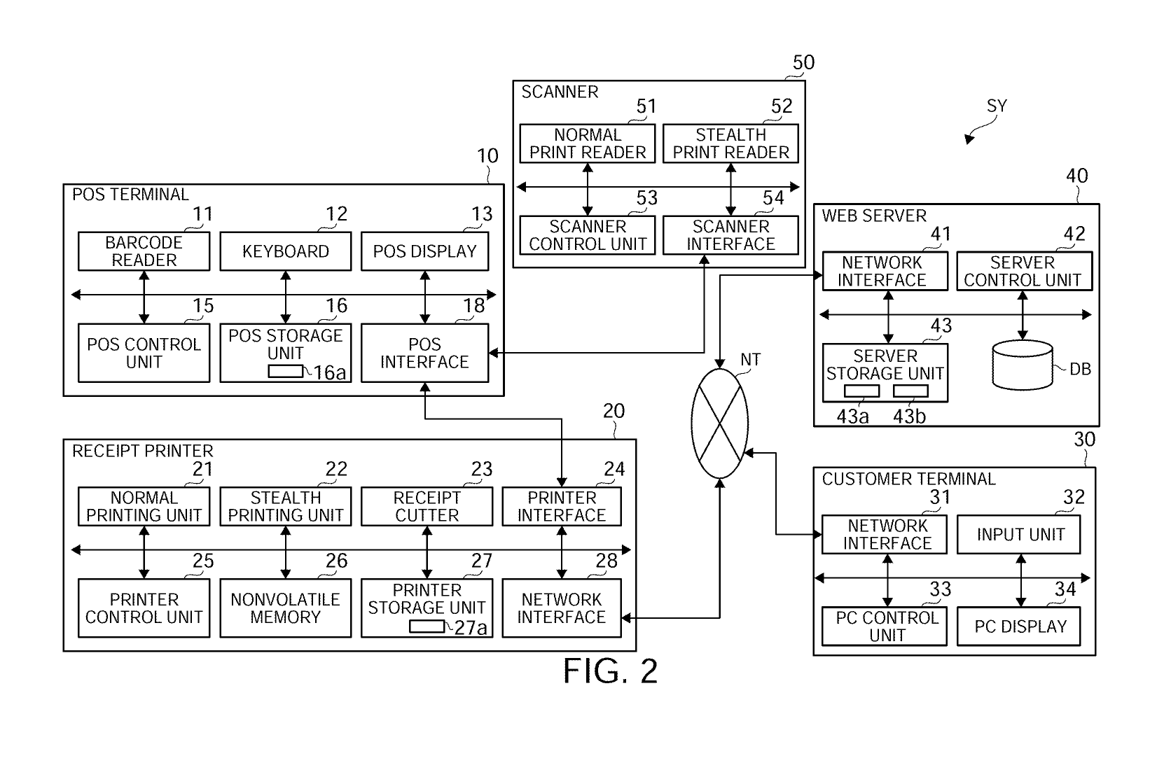

The control configuration of the receipt issuing system SY is described next with reference to FIG. 2. The POS terminal 10 has a barcode reader 11 for reading barcodes that are printed on or affixed to products, a keyboard 12 for inputting information such as product codes, a POS display 13 for displaying information such as product prices and sales total information, a POS control unit 15 rendered primarily by a CPU (central processing unit) for controlling POS terminal 10 operations, a POS storage unit 16 for storing, for example, a POS application 16a, and a POS interface 18 for connecting to the receipt printer 20, for example through a wired connection.

The control configuration of the receipt printer 20 is described next. The receipt printer 20 includes a normal printing unit 21 that prints using normal ink (i.e., a visible medium), a stealth printing unit 22 that prints using stealth ink (i.e., an invisible medium), a receipt cutter 23 for cutting the printed portion of a continuous receipt medium across the width, a printer interface 24 that is connected (e.g., a wired connection) to the POS terminal 10, a printer control unit 25 for controlling operation of the receipt printer 20, nonvolatile memory 26 (i.e., a specific storage area) for storing information, a printer storage unit 27 for storing an anti-counterfeiting printing program 27a for printing to prevent forgeries, and a network interface 28 connected to the network NT.

The normal printing unit 21 and stealth printing unit 22 print by using an inkjet printing process. Note that two separate inkjet heads may be used for discharging normal ink and discharging stealth ink, or a configuration in which the inkjet head has plural nozzle rows and discharges different ink from different nozzle rows may be used.

Device information (i.e., second information) such as the store number of the store where the receipt issuing system SY is installed, or a printer number unique to the receipt printer 20, is stored in nonvolatile memory 26.

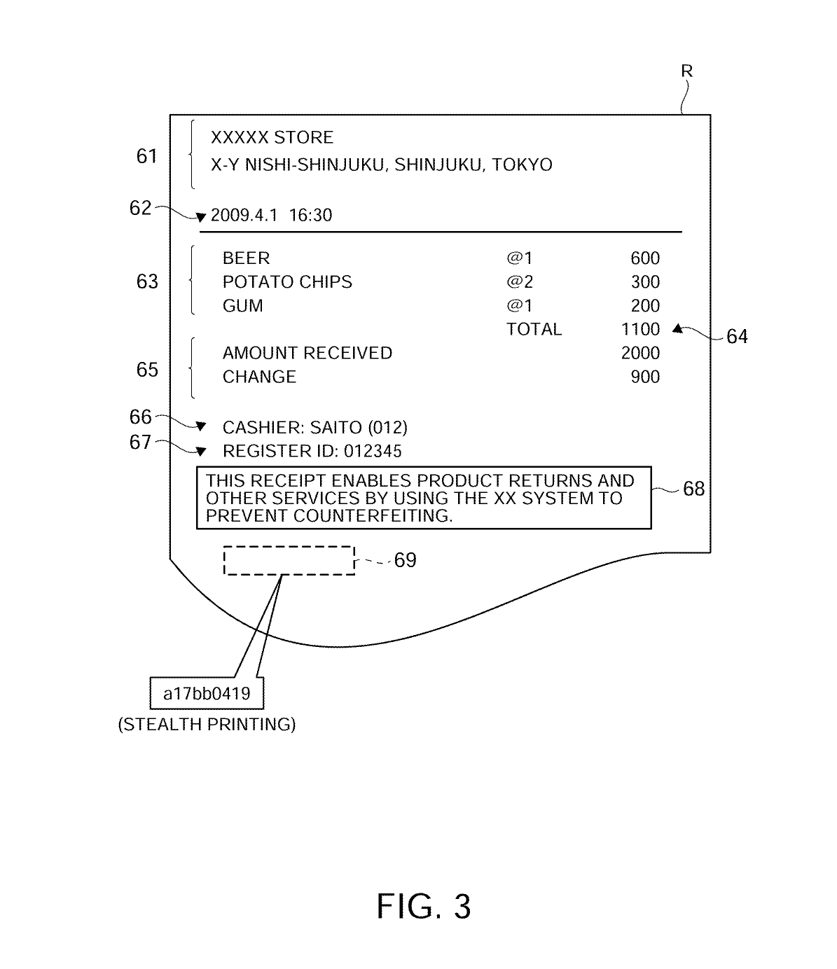

The anti-counterfeiting printing program 27a is a program for printing encrypted data 69 (see FIG. 3) on the receipt R for counterfeiting prevention. The printer control unit 25 determines according to the anti-counterfeiting printing program 27a if encrypted data is needed based on the transaction information acquired from the POS terminal 10, and executes an encryption process according to the result of this decision. If the encryption process is executed, the transaction information and encrypted data 69 are printed. If the encryption process is not executed, only the transaction information is printed. Note that the encrypted data 69 is acquired by encrypting some of the transaction information (such as the transaction date, sales total, or cash register operator number) and device information according to a specified encryption method.

The items printed on a receipt R are described next with reference to FIG. 3. As shown in the figure store information 61, transaction date and time information 62, product information 63, item total information 64, payment information 65, cash register operator information 66, and receipt identification information 67 is printed on the receipt R. These items are determined based on the transaction information produced by the POS terminal 10, and are all printed using the normal printing unit 21.

When encrypted data is determined necessary and the encryption process is executed, a message 68 and the encrypted data 69 are printed on the receipt R below the above items 61 to 67. The message 68 is printed by the normal printing unit 21, and the encrypted data 69 is printed by the stealth printing unit 22. In one example the message 68 is information that is read from the printer storage unit 27. Because the encrypted data 69 is not visible under normal light, its location is indicated in FIG. 3 by the dotted box.

Returning to FIG. 2, the control configuration of the customer terminal 30 is described next. A personal computer (PC) is used here as the customer terminal 30. The customer terminal 30 has a network interface 31 that is connected to the network NT, an input unit 32 such as a mouse or keyboard for inputting information, a PC control unit 33 that controls customer terminal 30 operations, and a PC display 34 for displaying information.

In this embodiment of the invention the input unit 32 is used primarily for inputting personal information. The personal information includes, for example, an e-mail address, a postal address, name, sex, age, or occupation (see FIG. 4A). The e-mail address in particular is used as the address to which the web server 40 sends when sending incentives, for example, to the customer terminal 30.

The control configuration of the web server 40 is described next. The web server 40 has a network interface 41 connected to the network NT, a server control unit 42 that controls web server 40 operations, a server storage unit 43 that stores a lottery program 43a for running a lottery and a coupon generating program 43b that generates data for printing coupons, and the database DB described above.

FIG. 4A shows information typically stored in the database DB. As shown in the figure, the database DB stores receipt information that is sent from the receipt printer 20 linked to personal information input from the customer terminal 30. The receipt information includes the transaction information that results from the transaction process executed by the POS terminal 10, and device information such as the store number and printer number for identifying a receipt printer 20.

FIG. 4B shows an example of a coupon 70. A coupon code 71, coupon name 72, a barcode 73 encoding the coupon code 71, and an expiration date 74 are printed on the coupon 70. The data printed on the coupon 70 is generated by the coupon generating program 43b. In some embodiments, the server control unit 42 runs a lottery to select receipt information stored in the database DB by means of the lottery program 43a, and sends coupon print data generated by means of the coupon generating program 43b to the lottery winner. The recipient (e.g., customer) to whom the coupon print data is sent prints the coupon print data by means of a printer not shown, and can use the coupon 70 by taking it to an appropriate store.

With reference again to FIG. 2, the control configuration of the scanner 50 is described next.

The scanner 50 has a normal print reader 51 that reads information printed using normal ink, a stealth print reader 52 that reads information (encrypted data 69) printed in stealth ink, a scanner control unit 53 that controls scanner 50 operations, and a scanner interface 54 for connection to the POS terminal 10 through a wired connection.

The normal print reader 51 may be rendered using a common scanner, and is not limited to a particular type of light source, such as an LED or a laser.

The stealth print reader 52 exposes the receipt R to infrared light using an infrared camera (such as a device having an infrared filter disposed to a CMOS sensor), and takes a picture of the reflection. Note that the normal print reader 51 and stealth print reader 52 may read the receipt R simultaneously or serially.

By means of the configuration described above, the scanner control unit 53 determines whether or not the receipt R is counterfeit based on the device information and the transaction information acquired by decrypting the output from the scanner control unit 53 and the stealth print reader 52. Whether a receipt R is counterfeit may be determined from, for example, whether the cash register operator number is a valid number, whether the transaction date and time are valid values, and/or whether the transaction total is a normal value. Counterfeits may also be determined based on a match between one or more of the transaction information items read by the normal print reader 51 (that is, one or more of items 61 to 67 in FIG. 3) and the information acquired by decryption. Note that the result of this counterfeit detection operation of the scanner 50 is displayed on the POS display 13 of the POS terminal 10.

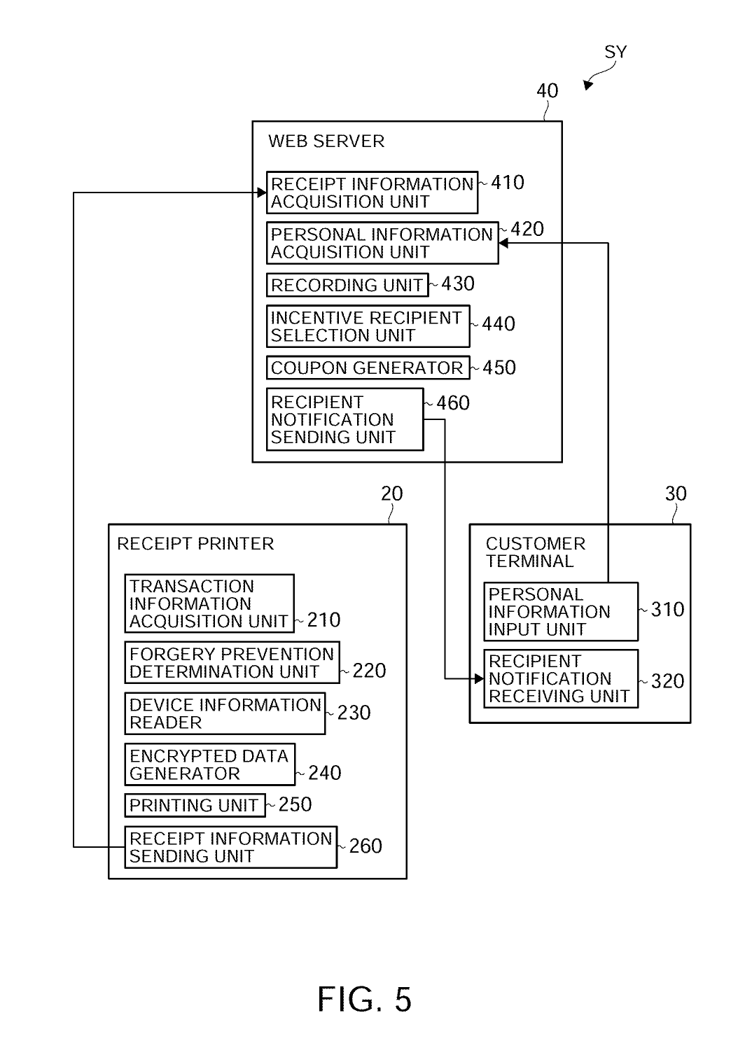

The main functional configuration of the receipt issuing system SY (receipt printer 20, customer terminal 30, and web server 40) is described next with reference to FIG. 5.

The receipt printer 20 has a transaction information acquisition unit 210, forgery prevention determination unit 220, device information reader 230, encrypted data generator 240, printing unit 250, and receipt information sending unit 260. The transaction information acquisition unit 210 acquires transaction information from the POS terminal 10 by means of the printer interface 24.

The forgery prevention determination unit 220 determines if encrypted data is necessary based on the acquired transaction information. In this embodiment of the invention encrypted data is determined to be necessary if it is determined from the item total information 64 (see FIG. 3) contained in the transaction information that the transaction total exceeds a specified amount (such as 1000 yen). The forgery prevention determination unit 220 also determines a forgery prevention rank based on the product information 63 contained in the transaction information. This forgery prevention rank is one of four levels A to D, for example, and the encryption method is determined according to the rank. For example, AES is used as the encryption method if the rank is A, triple DES is used if the rank is B, DES is used if the rank is C, and a password that is knowable by a certain person is used if the rank is D.

The device information reader 230 reads device information from the nonvolatile memory 26 by means of the printer control unit 25.

The encrypted data generator 240 generates the encrypted data 69 using the read device information and the transaction information acquired from the POS terminal 10 as a result of the printer control unit 25 executing an encryption program contained in the anti-counterfeiting printing program 27a. In this situation the encrypted data generator 240 determines the encryption method according to the forgery prevention rank determined by the forgery prevention determination unit 220, and encrypts using the selected encryption method.

The printing unit 250 prints the transaction information (items 61 to 67) and the message 68 using the normal printing unit 21 triggered by acquiring the transaction information from the POS terminal 10. If the forgery prevention determination unit 220 determines that encryption is necessary, the encrypted data 69 is also printed by the stealth printing unit 22.

The receipt information sending unit 260 sends the transaction information and device information as the receipt information to the web server 40. Note that the receipt information may be transmitted at the completion of each printing process, or receipt information for a plurality of receipts may be sent in a batch using down time after printing is completed. The receipt information is sent at the completion of each printing process in this embodiment as described below.

The functional configuration of the customer terminal 30 is described next. The main functional components of the customer terminal 30 are a personal information input unit 310 and a recipient notification receiving unit 320.

The personal information input unit 310 accesses the web server 40, selects the receipt information based on part of the transaction information (such as the receipt identification information 67 that uniquely identifies a particular receipt R), and inputs personal information as a result of the customer operating the input unit 32.

The recipient notification receiving unit 320 receives the result of the incentive award decision (the coupon 70 shown in FIG. 4B) from the web server 40 through the network interface 31. In some embodiments, only the customer terminal 30 of the customer that was selected as the lottery winner by the web server 40 receives the result of the incentive recipient selection.

The functional configuration of the web server 40 is described next.

The main functional components of the web server 40 include a receipt information acquisition unit 410, personal information acquisition unit 420, recording unit 430, incentive recipient selection unit 440, coupon generator 450, and recipient notification sending unit 460.

The receipt information acquisition unit 410 acquires the receipt information from the POS terminal 10 by means of the network interface 41.

The personal information acquisition unit 420 acquires personal information from the customer terminal 30 by means of the network interface 41.

When the server control unit 42 stores the acquired receipt information in the database DB and personal information is inputted from the customer terminal 30, the recording unit 430 stores the personal information linked to the corresponding receipt information.

The incentive recipient selection unit 440 determines by means of the server control unit 42 to whom the incentive is awarded based on the receipt information stored in the database DB. In this embodiment of the invention the awarded incentive is determined based on the transaction information and device information by means of a lottery using the lottery program 43a. An incentive appropriate to the transaction information or device information may also be awarded by, for example, determining the number of recipients based on the item total information 64 contained in the transaction information, changing the awarded product according to the purchased products, and/or issuing coupons targeted to a particular area according to the device information.

The coupon generator 450 generates print data for the coupon 70 using the coupon generating program 43b by means of the server control unit 42 according to the decision output from the incentive recipient selection unit 440.

The recipient notification sending unit 460 sends the print data generated by the coupon generator 450 to the customer terminal 30 through the network interface 41 by means of the server control unit 42.

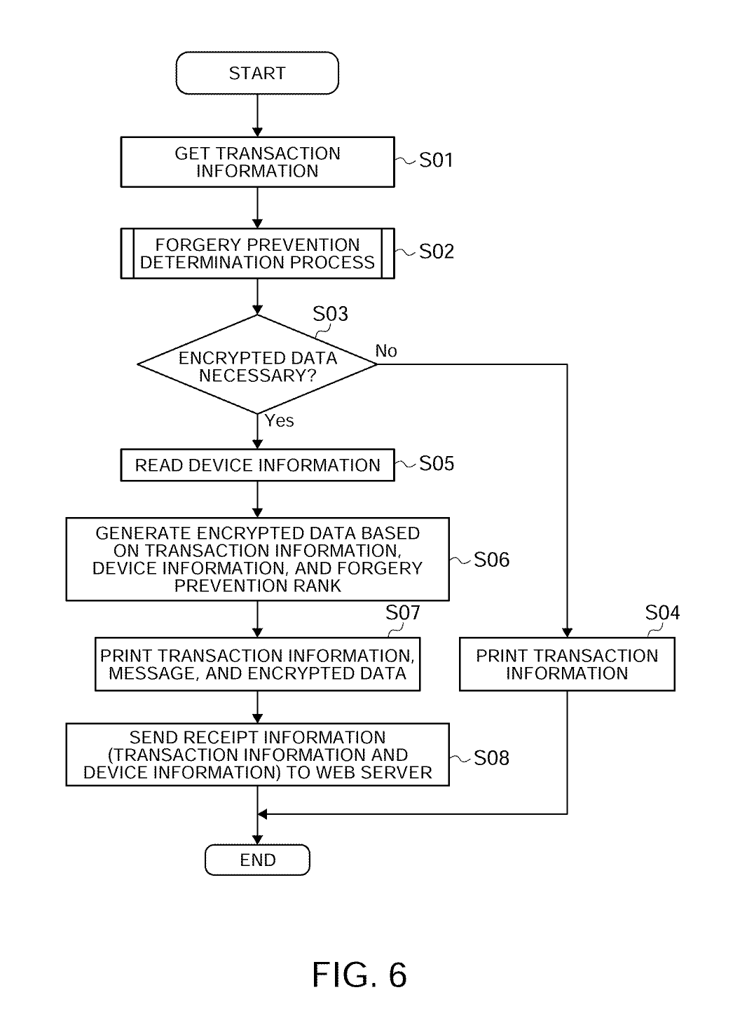

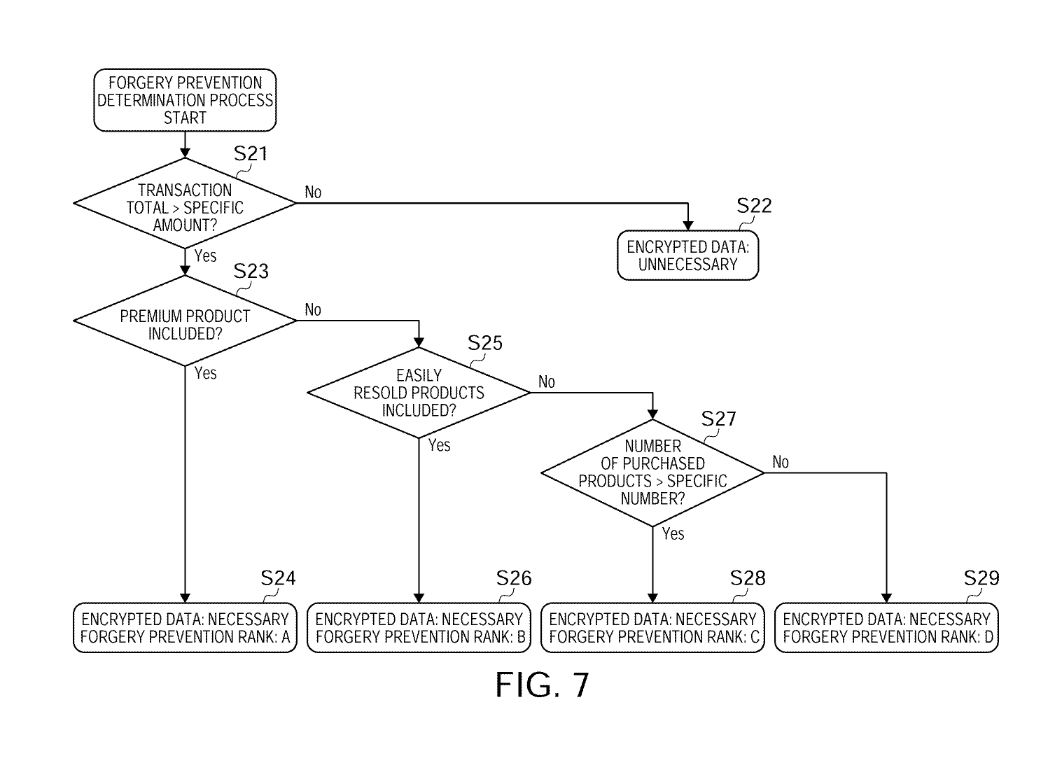

The printing process of the receipt printer 20 is described next with reference to the flow charts in FIG. 6 and FIG. 7. FIG. 6 shows the main routine of the printing process, and FIG. 7 shows a subroutine thereof.

As shown in FIG. 6, after acquiring the transaction information from the POS terminal 10 (S01), the receipt printer 20 (printer control unit 25) executes a forgery prevention determination process (S02). This forgery prevention determination process is described below with reference to FIG. 7. If encrypted data is determined unnecessary by the forgery prevention determination process (S03 returns No), a receipt R on which only the acquired transaction information is printed is issued (S04).

If encrypted data is determined necessary by the forgery prevention determination process (S03 returns Yes), device information is acquired from nonvolatile memory 26 (505), and the receipt printer 20 generates encrypted data 69 (S06) based on the transaction information, device information, and the forgery prevention rank determined by the forgery prevention determination process (S02). A receipt R is then printed with the transaction information, message 68, and encrypted data 69 (S07). The receipt printer 20 then sends the receipt information (transaction information and device information) to the web server 40 (S08).

The forgery prevention determination process (S02) is described next with reference to FIG. 7.

The receipt printer 20 (printer control unit 25) first determines if the transaction total exceeds a specific amount based on the transaction information acquired from the POS terminal 10 (S21). If the transaction total does not exceed the specific amount (S21 returns No), it determines that encrypted data is not needed (S22).

If the transaction total exceeds the specific amount (S21 returns Yes), whether or not premium products are included in the purchased products is determined (S23). Whether premium products are included is determined based on whether a specific product name or product code is contained in the product information 63. If premium products are included (S23 returns Yes), encrypted data is necessary and the forgery prevention rank is set to A (the highest rank) (S24).

If premium products are not included (S23 returns No), whether there are any products that can be easily converted to money (or can be resold) are included in the purchased products is determined (S25). This step also determines if a specific product name or product code is contained in the product information 63. If a product that is easily converted to money or resold is included (S25 returns Yes), the forgery prevention rank is set to B (S26).

If a product that is easily converted to money or resold is not included (S25 returns No), whether the number of purchased products exceeds a specific number is determined (S27). The decision in this step is based on the number of products contained in the product information 63. If the purchased product count exceeds a specific number (S27 returns Yes), the forgery prevention rank is set to C (S28). If the purchased product count does not exceed the specific number (S27 returns No), the forgery prevention rank is set to D (the lowest rank) (S29).

Note that the conditions evaluated in the forgery prevention determination process are not limited to those described above, and other conditions may be used. For example, encrypted data is determined necessary if the transaction total exceeds a specific amount (S21 returns Yes) in the foregoing example, but in some embodiments encrypted data may be determined necessary if product information for a specific product is included in the product information 63, or if the number of products included in the product information 63 exceeds a specific number. Encrypted data may also be determined necessary if the number of products that can be easily converted to money or resold exceeds a specific number.

The number of decision steps and the number of forgery prevention ranks are also not limited. The user may also conceivably be enabled to desirably set the decision conditions and forgery prevention ranks (encryption methods). In some embodiments, encrypted data is determined to be not necessary when the transaction total does not exceed a specific amount in step S21, but the encrypted data may also be determined unnecessary based on the type of products. Products that are not premium products and products that are not easily resold or converted to money are examples of this type of product.

As described above, a receipt issuing system SY according to this embodiment of the invention prints encrypted data 69 on a receipt R only when encrypted data is determined to be necessary, or in other words does not print the encrypted data 69 when encrypted data is determined to not be necessary, and compared with a configuration in which the encrypted data 69 is printed on all receipts R can therefore greatly reduce the use of stealth ink that is needed to print the encrypted data 69. As a result, the operating cost required for receipt printing can be reduced while continuing to effectively prevent counterfeiting.

In some embodiments, existing POS terminals 10 can be used because the counterfeiting prevention function can be rendered by the receipt printer 20. As a result, the initial cost can also be reduced because modifying the POS terminal 10 is not necessary.

In some embodiments, because the encrypted data 69 that is used for counterfeiting prevention is generated based on device information, that is, information that is unique to a receipt printer 20, the receipt printer 20 that printed a receipt R can be identified by decrypting the encrypted data 69. The reliability of a receipt R can be improved because printing by a controlled receipt printer 20 can be proven by means of the device information obtained by decryption. In some embodiments, if the device information obtained by decryption is information that is not possible (i.e., is invalid), it can also be used for authenticity verification, such as for ascertaining whether the receipt R was forged.

Furthermore, because the forgery prevention determination process determines that encrypted data is necessary when the transaction total exceeds a specific amount (that is, is a large amount), significant damages (losses) at the retail level can be prevented. Because the forgery prevention determination process determines a forgery prevention rank based on the transaction information and produces encrypted data 69 using an encryption method selected according to the selected forgery prevention rank, significant damages (losses) at the retail level can be prevented even more effectively by using a more complex encryption method when the potential loss from a forged receipt is high. In some embodiments, because the encrypted data 69 is printed with stealth ink, duplicating the receipt R is made more difficult and the anti-counterfeiting effect can be further improved.

In some embodiments, because customers can receive some sort of incentive by lottery after the receipt R is issued as a result of registering their personal information in the web server 40, the receipt R can be prevented from being discarded by the customer. As a result, illegal activities such as someone picking up a discarded receipt R and using it to return a product from inside the store, or copying a receipt R and producing a counterfeit receipt, can be prevented. Because the retail store can get personal information from the customer terminal 30, the receipt issuing system SY according to this embodiment of the invention can provide the motivation for introducing a member registration system or other customer relationship management (CRM) system, and the receipt issuing system SY can be used to acquire personal customer information. In some embodiments, receipt information and personal information stored in the database DB can be used as marketing information to develop marketing strategies, for example.

Note, that In some embodiments, that the incentive recipient selection unit 440 in the foregoing embodiment issues coupons 70 by lottery, but incentives may be given to all customers that have registered personal information. In some embodiments, incentives other than coupons 70, such as notification of special sales events or a new lottery ticket, may also be awarded.

In some embodiments, the recipient notification sending unit 460 transmits data for printing a coupon 70 in the foregoing embodiment, but simply notification of selection by the incentive recipient selection unit 440 may instead be sent with the actual incentive awarded at a later date at the store. In this situation the recipient notification sending unit 460 may send a message such as “You have won product XX. Please come in to exchange the selected receipt R for the product.” In this configuration the receipt R is used as the winning ticket, and discarding the receipt R can be more effectively prevented.

In some embodiments, the recipient notification sending unit 460 may send notification of the lottery result even when an incentive is not awarded (when not selected by the lottery). For example, a message such as “We are sorry, but you didn't win this time. We hope you will try again next time” may be sent.

In some embodiments, the encrypted data 69 is printed by the stealth printing unit 22 in the foregoing embodiment, but when the receipt printer 20 does not have a stealth printing unit 22, the encrypted data 69 may be printed by the normal printing unit 21. Further alternatively, the user may be enabled to select whether to print the encrypted data 69 using the normal printing unit 21 or to print using the stealth printing unit 22. In addition, the stealth printing unit 22 may be used for printing when the transaction information satisfies specific conditions (such as when the transaction total is particularly high), and the normal printing unit 21 may be used for printing otherwise.

In some embodiments, a message 68 and encrypted data 69 may be printed on all receipts R regardless of the result of the forgery prevention determination process with the encrypted data 69 printed by the stealth printing unit 22 when the transaction information satisfies a particular condition, and the encrypted data 69 printed by the normal printing unit 21 otherwise.

Furthermore, transaction information and device information is stored in the database DB as the receipt information in the foregoing embodiment, but the encrypted data 69 may be stored instead or in addition thereto. In some embodiments, the incentive recipient selection unit 440 may award incentives based on the encrypted data 69. Because the encrypted data 69 is generated based on the transaction information and device information as described above, an incentive appropriate to the transaction information and device information can be indirectly awarded by awarding incentives based on the encrypted data 69. Running a lottery (using the encrypted data 69 as the lottery number) based on the encrypted data 69 is also possible. In addition, if the encrypted data 69 is printed using normal ink, the encrypted data 69 can be used as a number for identifying the receipt information when inputting personal information.

The encrypted data 69 is printed below the transaction information in the foregoing embodiment, but the encrypted data 69 may alternatively be printed over a part of the transaction information. In some embodiments, a character string is printed as the encrypted data 69 above, but a code image, such as a linear barcode or two-dimensional because, may be printed.

In some embodiments, the encrypted data 69 is printed using an inkjet method in the foregoing embodiment. The printing method is not so limited and thermal printing, dot impact printing, thermal transfer printing, or another method may be used. Furthermore, the encrypted data 69 is printed using normal ink and stealth ink above, but fluorescent ink, infrared ink, or other type of ink may be used instead of stealth ink. In some embodiments, in addition to a medium that is made visible by light, media that is made visible by heat, chemical reaction, or changing paper properties may be used. In some embodiments, any medium that is made visible by applying a specific process may be used.

In some embodiments, the authenticity of a receipt R is determined by the scanner 50 in the foregoing embodiment, but authenticity may be determined by the POS terminal 10. In some embodiments, the scanner 50 in such a configuration simply reads and sends the encrypted data 69 to the POS terminal 10, and the POS terminal 10 then decrypts the encrypted data 69 and determines authenticity.

In some embodiments, the receipt printer 20 executes the forgery prevention determination process in the foregoing embodiment, but the POS terminal 10 may execute the forgery prevention determination process. Generating the encrypted data 69 may also be done on the POS terminal 10 side. However, when the encrypted data 69 is generated based on device information, the device information (e.g., store number, terminal number of the POS terminal 10) must be previously stored in the POS terminal 10. In some embodiments, in this configuration the POS terminal 10 may send the message 68 and encrypted data 69 to the receipt printer 20 as part of the transaction information. In some embodiments, the receipt printer 20 only prints based on the transaction information sent from the POS terminal 10, and the special configuration for rendering an anti-counterfeiting function is the ability to print using stealth ink. In this configuration the POS terminal 10 and the receipt printer 20 render the “print processing device” in the accompanying claims. Furthermore, because this configuration enables the POS terminal 10 to execute the forgery prevention determination process and generate encrypted data 69, a complicated calculation process is not required on the receipt printer 20 side, and a drop in performance can be prevented.

In some embodiments, a lottery is run using the web server 40 in the foregoing embodiment, but the encrypted data 69 can simply function as an exchange number or lottery number for receiving an incentive without using a web server 40. This configuration can prevent discarding a receipt R without incurring the initial cost of constructing a web server 40.

The components and processing steps of the receipt issuing system SY described in the foregoing embodiment can also be rendered as instructions for a machine configured as a software program. The program can also be stored on a machine readable medium such as a CD-ROM or flash memory device, for example. In some embodiments, a program for causing a computer to function as the components of the receipt issuing system SY, a program for executing the process steps of the receipt issuing system SY on a computer, and a recording medium that records these, are also included in the scope of the present invention.

Furthermore, a configuration in which a print processing device according to the invention is applied to a receipt printer 20 is described in the foregoing embodiment, but the print processing device of the invention can also be applied to devices that can print output other than receipts R. Examples of such print output include coupons, monetary notes, deeds, receipts, lottery numbers, and certificates. In some embodiments, use of the invention is valuable when printing output, such as documents that can be exchanged for money or used for proof of purchase, requires encrypted data. Other suitable changes are also possible without departing from the scope of the invention.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A control method for a print processing device that produces printed output, the method comprising:
determining that encrypted data is necessary to prevent forgery based on first information, which is variable information;
generating the encrypted data using at least a part of the first information when encrypted data is determined necessary to prevent the forgery; and
printing the first information and the encrypted data when encrypted data is determined necessary to prevent the forgery,
wherein the first information is only printable when encrypted data is determined to be necessary.

2. The method of claim 1, further comprising:
reading second information, which is information unique to the print processing device, from a specific storage area,
wherein the encrypted data is generated from the first information and the second information.

3. The method of claim 1, wherein the print processing device is a receipt printing device connected to a POS terminal.

4. The method of claim 3, wherein the first information comprises transaction information, which is a result of a transaction process of the POS terminal, from the POS terminal.

5. The method of claim 4, wherein the method further comprises:
reading device information using the receipt printing device, the information being unique to the receipt printing device, from a specific storage area,
wherein the encrypted data is generated from the transaction information and the device information.

6. The method of claim 3, wherein encrypted data is determined necessary if a transaction total contained in the transaction information exceeds a specific amount.

7. The method of claim 3, wherein encrypted data is determined necessary if product information for a specific product is contained in the transaction information.

8. The method of claim 3, wherein encrypted data is determined necessary if the number of products contained in the transaction information exceeds a specific number.

9. The method of claim 3, further comprising:
determining a forgery prevention rank using the transaction information.

10. The method of claim 9, wherein the encrypted data is generated according to the forgery prevention rank.

11. The method of claim 3, wherein determining that the encrypted data is necessary comprises determining a type of product contained in the transaction information.

12. The method of claim 3, wherein the encrypted data functions as an exchange number or a lottery number for receiving an incentive.

13. The method of claims 3, wherein the encrypted data is printed using invisible ink.

14. A print processing device that produces printed output, the device comprising:
a forgery prevention determination unit configured to determined if encrypted data is necessary based on first information, which is variable information;
an encrypted data generating unit configured to generate encrypted data using at least a part of the first information when encrypted data is determined necessary by the forgery prevention determination unit; and
a printing unit configured to print the first information and the encrypted data when encrypted data is determined necessary by the forgery prevention determination unit, and is configured to print only the first information when encrypted data is determined unnecessary.

15. The print processing device of claim 14, wherein the first information comprises transaction information.

16. The print processing device of claim 15, further comprising:
a transaction information acquisition unit that is configured to acquire the transaction information, which is a result of a transaction process of a POS terminal, from the POS terminal.

17. The print processing device of claim 16, further comprising:
a receipt information sending unit that is configured to send receipt information including the transaction information to a web server.

18. The print processing device of claim 17, wherein a customer terminal is in communication with the receipt printing device, the customer terminal including:
a personal information input unit that is configured to access the web server, specifies the receipt information using a part of the transaction information, and inputs personal information.

19. The print processing device of claim 18, wherein the web server includes:
a database that is configured to store the receipt information acquired from the receipt printing device and the personal information acquired from the customer terminal linked together,
an incentive recipient selection unit that is configured to determine an incentive recipient from the receipt information stored in the database, and
a recipient notification sending unit that is configured to send the result of the selection decision by the incentive recipient selection unit to the customer terminal.

20. The print processing device of claim 19, wherein:
the receipt printing device includes a device information reading unit that is configured to read device information, which is information unique to the receipt printing device, from a specific storage area; and
the encrypted data generating unit is configured to generate the encrypted data using the transaction information and the device information.

21. The print processing device of claim 20, wherein:
the receipt information sending unit is configured to send the transaction information and the device information to the web server; and
the incentive recipient selection unit is configured to determine the incentive based on the transaction information and the device information.

22. A machine readable medium including instructions configured as software, which when executed by a computer causes the computer to perform the method of:
determining that encrypted data is necessary to prevent forgery based on first information, which is variable information;
generating the encrypted data using at least a part of the first information when encrypted data is determined necessary to prevent the forgery; and
printing the first information and the encrypted data when encrypted data is determined necessary to prevent the forgery, and wherein the first information is only printable when encrypted data is determined to be necessary.

23. The machine readable medium of claim 22, wherein the method further comprises:
reading second information, which is information unique to the print processing device, from a specific storage area,
wherein the encrypted data is generated from the first information and the second information.

24. The machine readable medium of claim 22, wherein the computer is a receipt printing device connected to a POS terminal.

25. The machine readable medium of claim 23, wherein the first information comprises transaction information received from the POS terminal.
